(19) United States
(12) Patent Application Publication
(10) Pub. No.: US 2009/0161671 A1
(43) Pub. Date: Jun. 25, 2009

(54) SYSTEM AND METHOD FOR DRIVING A STEP MOTOR

(75) Inventors: CHIH-KUANG CHANG, Tu-Cheng (TW); WEI-QI SUN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/233,542

(22) Filed: Sep. 18, 2008

(30) Foreign Application Priority Data
Dec. 20, 2007 (CN) 200710203287.8

(51) Int. Cl. H04L 12/56

(52) U.S. Cl. 370/389

(57) ABSTRACT

A system for driving a step motor is provided. The system receives a data packet from a computer, wherein the data packet comprises a header data and a main data. An identification of the main data is determined according to the header data. A selected magnification level of a lens module connected with the step motor is converted into drive signals for driving rotation of the step motor upon the condition that the identification of the main data is a numerical zoom value corresponding to the selected magnification level.

### BACKGROUND

1. Technical Field

Embodiments of the present disclosure generally relate to step motors, and more particularly, to a system and a method for driving a step motor.

2. Description of Related Art

A step motor rotates by a predetermined angle, namely a step angle, on application of one pulse to the step motor. Step motors have been widely used as a core driving source in many fields, such as, factory automation, and precision measurement industry.

In the precision measurement industry, the step motor may be mounted inside an image measurement machine for controlling and adjusting zoom of a lens module of the image measurement machine via rotation to a predetermined position. What is needed, therefore, is a system and method for driving rotation of the step motor, which can control and adjust zoom of the lens module effectively and accurately.

### SUMMARY

A system for driving a step motor is provided. The system includes a first data packet receiving module, a MCU determining module, a converting module, and at least one processor. The first data packet receiving module is configured for receiving a first data packet from a computer, wherein the first data packet comprises a header data and a main data, wherein the header data defines an identification of the main data, and wherein the main data defines a numerical zoom value corresponding to a selected magnification level of the lens module. The MCU determining module is configured for determining the identification of the main data in the first data packet according to the header data. The converting module is configured for converting the selected magnification level of the lens module into drive signals to drive rotation of the step motor, upon the condition that the identification of the main data is the numerical zoom value corresponding to the selected magnification level of the lens module The at least one processor is configured for executing the first data packet receiving module, the MCU determining module, and the converting module.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a block diagram of one embodiment of a system for driving a step motor;

FIG. 2 is a block diagram of one embodiment of a computer and a MCU in FIG. 1 comprising function modules;

FIG. 3 is a flowchart illustrating one embodiment of a method for driving a step motor; and

FIG. 4 is a flowchart illustrating one embodiment of a method of the MCU converting the selected magnification level into drive signals as described in block S15 in FIG. 3.

### DETAILED DESCRIPTION OF CERTAIN INVENTIVE EMBODIMENTS

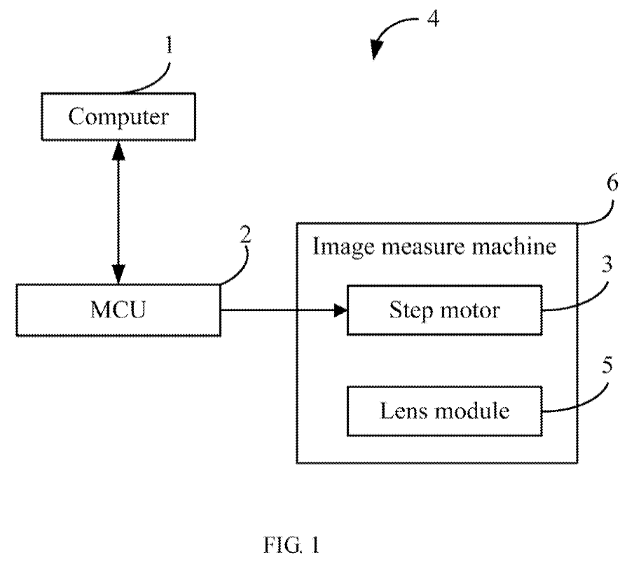

FIG. 1 is a block diagram of one embodiment of a system 4 for driving a step motor 3. In one embodiment, the system 4 may include a computer 1 and a microcontroller unit (MCU) 2. The MCU 2 is electronically connected with the computer 1 and the step motor 3. In one embodiment, the step motor 3 may be installed in an image measurement machine 6.

The computer 1 is configured for receiving zoom commands of a lens module 5 of the image measuring machine 6. It may be understood that, the zoom command is command that controls the lens module 5 to zoom/magnify on a selected area of an object. In one embodiment, the zoom command may include a numerical zoom value corresponding to a selected magnification level of the lens module 5, wherein the numerical zoom value may be, for example, 1, 4, or 9. The lens module 5 is installed in the image measurement machine 6, and be connected with the step motor 3. Zoom of the lens module 5 can be controlled and adjusted via the rotation of the step motor 3. The computer 1 is further configured for packing the numerical zoom value into a first data packet, and sending the first data packet to the MCU 2.

The MCU 2 is arranged and configured for receiving the first data packet from the computer 1, processing the first data packet, and generating drive signals that drive rotation of the step motor 3 according to the numerical zoom value.

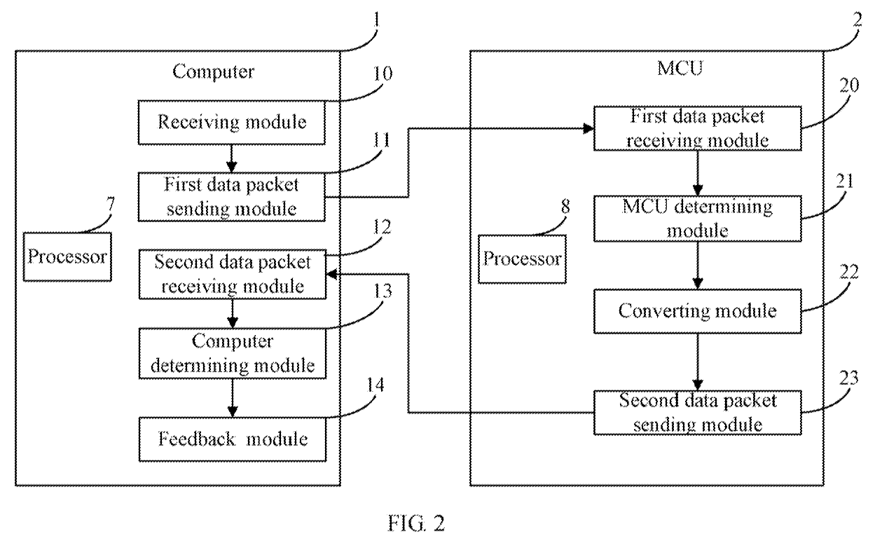

FIG. 2 is a block diagram of one embodiment of the computer 1 and the MCU 2 in FIG. 1 comprising function modules. In one embodiment, the computer 1 may include a receiving module 10, a first data packet sending module 11, a second data packet receiving module 12, a computer determining module 13, and a feedback module 14. In one embodiment, the MCU 2 may include a first data packet receiving module 20, a MCU determining module 21, a converting module 22, and a second data packet sending module 23. The modules 10, 11, 12, 13, and 14 together with the modules 20, 21, 22, and 23 recited above perform one or more tasks for driving rotation of the step motor 3. It may be understood that, one or more specialized or general purpose processors, such as a processor 7 and a processor 8 in the computer 1 and the MCU 2, respectively, may be used to execute the software function modules 10, 11, 12, 13, and 14, and the software function modules 20, 21,22, and 23.

The receiving module 10 is configured for receiving a zoom command of the lens module 5. As mentioned above, the zoom command may include a numerical zoom value corresponding to a selected magnification level of the lens module 5.

The first data packet sending module 11 is configured for packing the numerical zoom value to generate a first data packet, and sending the first data packet to the MCU 2. The first data packet may include a header data and a main data. The header data defines an identification of the main data, and may be represented as a predetermined character, such as an “M.” The main data is the numerical zoom value. For example, if the first data packet is “M9,” the header data “M” defines that the main data of the first data packet is identified as a selected magnification level, and the main data “9” is the numerical zoom value.

The first data packet receiving module 20 is configured for receiving the first data packet from the computer 1.

The MCU determining module 21 is configured for determining the identification of the main data in the first data packet according to the header data of the first data packet. As mentioned above, if the header data of the first data packet is the character “M,” the MCU determining module 21 determines that the main data in the first data packet is identified as the selected magnification level. The MCU determining module 21 is further configured for determining if the main data in the first data packet is valid when the main data is identified as the selected magnification level. For example, if the selected magnification level is preset as 1-9, the main data in the first data packet is valid if more than 0, and less than or equal to 9.

The converting module 22 is configured for converting the selected magnification level into drive signals so as to drive the step motor 3 to rotate to a predetermined position. It will be understood that if the step motor 3 rotates to the predetermined position, the zoom of the lens module 5 can be adjusted accurately. The drive signals may include a pulse signal and a direction signal. It may be understood that the pulse signal is a pulse number that can drive the step motor 3 rotate to the predetermined position. The direction signal is a direction that the step motor 3 rotate to. The direction may be upwards or downwards. In one embodiment, a relationship between magnification level of the lens module 5 and pulse number to drive the step motor 3 to rotate may be stored in a table in the MCU 2. For example, the table may comprise data that 1× magnification level corresponds to a 2,000 pulse number, 4× magnification level corresponds to a 10,000 pulse number, 9× magnification level corresponds to a 18,000 pulse number, and so on. The converting module 22 may generate the direction signal by comparing a current magnification level of the lens module 5 with the selected magnification level. The direction may be upwards if the selected magnification level is more than the current magnification level. Otherwise, the direction may be downwards if the selected magnification level is less than the current magnification level. Finally, the converting module 22 generates the pulse signal by subtracting a pulse number corresponding to the current magnification level from a pulse number corresponding to the selected magnification level.

The second data packet sending module 23 is configured for packing a rotation result of the step motor 3 to generate a second data packet, and sending the second data packet to the computer 1. The rotation result of the step motor 3 comprises information defining whether the step motor 3 has rotated to the predetermined position or not rotated to the predetermined position. In one embodiment, the second data packet may include a header data, a main data, and a footer data. The header data and the main data of the second data packet have substantially the same function as the header data and the main data of the first data packet respectively. The footer data defines the rotation result of the step motor 3, and may be represented as a predetermined character, such as a “K” or an “N.” In one embodiment, if the footer data of the second data packet is the “K,” the step motor 3 has rotated to the predetermined position. Otherwise, if the footer data of the second data packet is the “N,” the step motor 3 has not rotated to the predetermined position.

The second data packet receiving module 12 is configured for receiving the second data packet from the MCU 2.

The computer determining module 13 is configured for determining if the step motor 3 has rotated to the predetermined position according to the second data packet. To do so, the computer determining module 13 determines if the main data in the second data packet is identified as the selected magnification level according to the header data of the second data packet. Then, the computer determining module 13 determines if the step motor has rotated to the predetermined position according to the footer data of the second data packet.

The feedback module 14 is configured for outputting error information if the step motor 3 has not rotated to the predetermined position. The outputted error information may be outputted to a display of the computer 1 and/or stored in an error log in a storage data system of the computer 1.

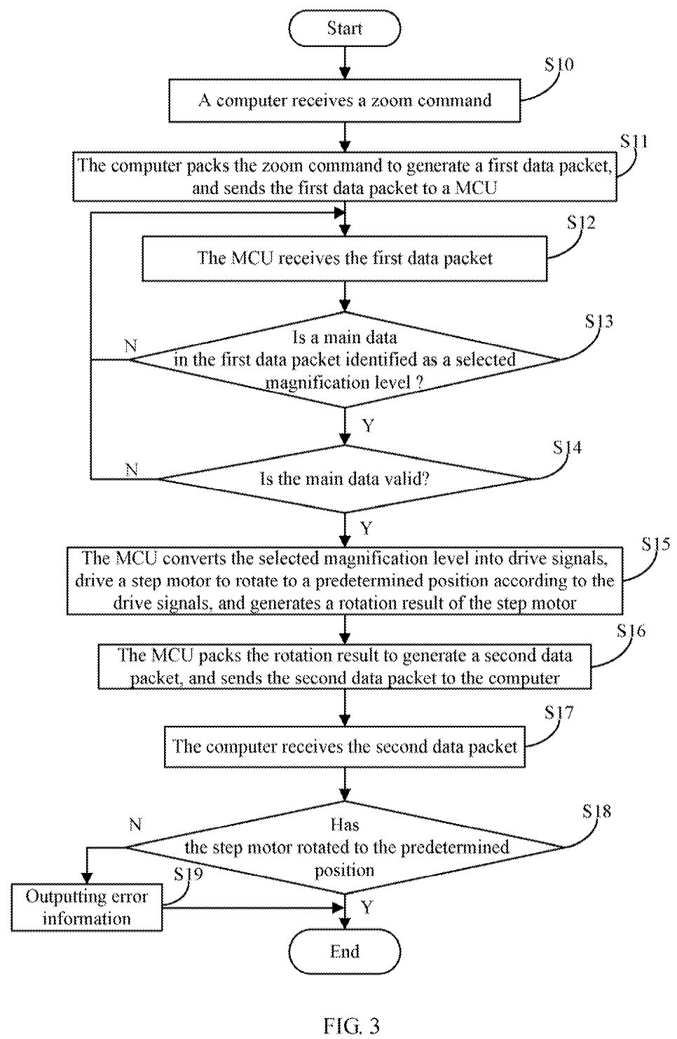

FIG. 3 is a flowchart illustrating one embodiment of a method for driving a step motor. Depending on the embodiment, in FIG. 3, additional blocks may be added, others removed, and the ordering of the blocks may be changed.

In block S10, the receiving module 10 of the computer 1 receives a zoom command of the lens module 5. As mentioned above, the zoom command includes a numerical zoom value corresponding to a selected magnification level of the lens module 5, wherein the numerical zoom value may be, for example, 1, 4, or 9.

In block S11, the first data packet sending module 11 packs the numerical zoom value to generate a first data packet, and sends the first data packet to the MCU 2. As mentioned above, the first data packet may include a header data and a main data. The header data defines identification (type) of the main data, and may be represented as a predetermined character, such as an “M.” The main data is the numerical zoom value corresponding to the selected magnification level of the lens module 5.

In block S12, the first data packet receiving module 20 of the MCU 2 receives the first data packet from the computer 1.

In block S13, the MCU determining module 21 determines if the main data in the first data packet has been identified as the selected magnification level according to the header data of the first data packet. As mentioned above, if the header data of the first data packet is “M,” the main data in the first data packet has been identified as the selected magnification level, and the flow moves to block S14. Otherwise, if the header data of the first data packet is not “M,” the main data in the first data packet has not been identified as the selected magnification level, then, the flow moves to block S12.

In block S14, the MCU determining module 21 further determines if the main data in the first data packet is valid. As mentioned above, if the numerical zoom value is more than 0, and less than or equal to 9, the main data in the first data packet is valid, and the flow moves to block S15. Otherwise, the main data in the first data packet is invalid, and the flow moves to block S12.

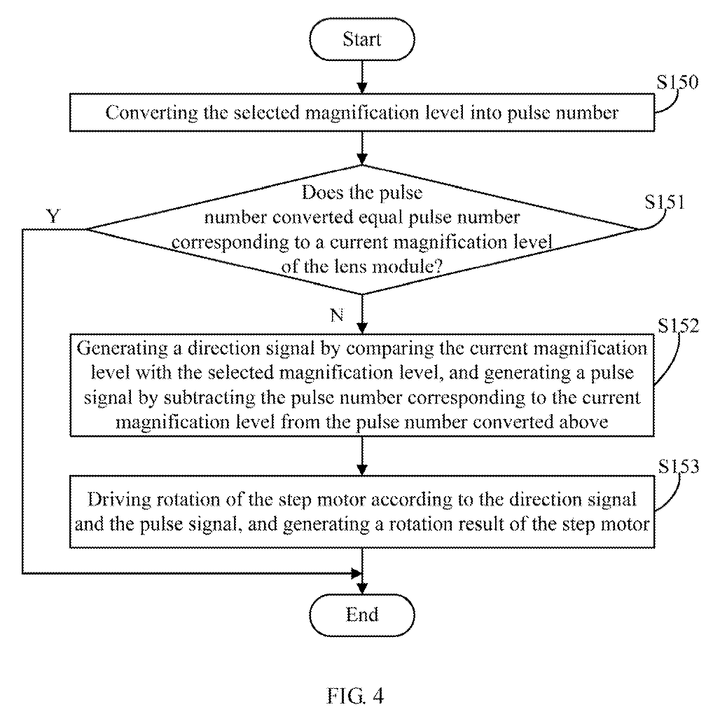

In block S15, the converting module 22 of the MCU 2 converts the selected magnification level into drive signals (detailed description is given in FIG. 4), drives the step motor 3 to rotate to a predetermined position according to the drive signals, and generates a rotation result of the step motor 3. As mentioned above, the drive signals may include a pulse signal and a direction signal. The pulse signal is a pulse number that can drive the step motor 3 rotate to the predetermined position. The direction signal is a direction that the step motor 3 rotate to. The direction may be upwards or downwards.

In block S16, the second data packet sending module 23 packs the rotation result of the step motor 3 to generate a second data packet, and sends the second data packet to the computer 1. As mentioned above, the second data packet may include a header data, a main data, and a footer data. The header data and the main data of the second data packet have substantially the same function as the header data and the main data of the first data packet respectively. The footer data defines the rotation result of the step motor 3, and may be represented as a predetermined character, such as a “K” or an “N.” If the footer data of the second data packet is the “K,” the step motor 3 has rotated to the predetermined position.

In block S17, the second data packet receiving module 12 receives the second data packet from the MCU 2.

In block S18, the computer determining module 13 determines if the step motor 3 has rotated to the predetermined position according to the second data packet. As mentioned above, the computer determining module 13 firstly determines if the main data in the second data packet is identified as the selected magnification level according to the header data of the second data packet. Then, the computer determining module 13 determines if the step motor 3 has rotated to the predetermined position according to the footer data of the second data packet. If the footer data of the second data packet is “K,” the step motor 3 has rotated to the predetermined position and the flow ends. Otherwise, if the footer data of the second data packet is “N,” the step motor 3 has not rotated to the predetermined position, then the flow moves to block S19.

In block S19, the feedback module 14 of the computer 1 outputs error information if the step motor 3 has not rotated to the predetermined position.

FIG. 4 is a flowchart illustrating one embodiment of a method of the MCU 2 converting the selected magnification level into drive signals as described in block S15 in FIG. 3. Depending on the embodiment, in FIG. 4, additional blocks may be added, others removed, and the ordering of the blocks may be changed.

In block S150, the converting module 22 converts the selected magnification level of the lens module 5 into pulse number according to the table in the MCU 2.

In block S151, the converting module 22 determines if the pulse number converted above equal pulse number corresponding to a current magnification level of the lens module 5. The flow ends if the pulses converted above equals the pulse corresponding to the current magnification level. The flow moves to block 152 if the pulse number converted above do not equal the pulse number corresponding to the current magnification level.

In block S152, the converting module 22 generates the direction signal by comparing the current magnification level with the selected magnification level, and further generates the pulse signal by subtracting the pulse number corresponding to the current magnification level from the pulse number converted above.

In block S153, the converting module 22 drives rotation of the step motor 3 according to the pulse signal and the direction signal, and generates the rotation result of the step motor 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for driving a step motor for controlling a lens module in an image measuring machine, the system comprising:
a first data packet receiving module configured for receiving a first data packet from a computer, wherein the first data packet comprises a header data and a main data, wherein the header data defines an identification of the main data, and wherein the main data defines a numerical zoom value corresponding to a selected magnification level of the lens module;
a MCU determining module configured for determining the identification of the main data in the first data packet according to the header data;
a converting module configured for converting the selected magnification level of the lens module into drive signals to drive rotation of the step motor, upon the condition that the identification of the main data is the numerical zoom value corresponding to the selected magnification level of the lens module; and
at least one processor configured for executing the first data packet receiving module, the MCU determining module, and the converting module.

2. The system as described in claim 1, wherein the drive signals comprise a pulse signal and a direction signal.

3. The system as described in claim 1, wherein the computer comprises:
a receiving module configured for receiving a zoom command comprising the numerical zoom value corresponding to the selected magnification level of the lens module; and
a first data packet sending module configured for packing the numerical zoom value to generate the first data packet.

4. The system as described in claim 1, further comprising:
a second data packet sending module configured for packing a rotation result of the step motor to generate a second data packet.

5. The system as described in claim 4, wherein the rotation result comprises information defining whether the step motor 3 has rotated to the predetermined position or not rotated to the predetermined position.

6. The system as described in claim 5, wherein the second data packet comprises a header data, a main data, and a footer data.

7. The system as described in claim 6, the computer further comprises:
a second data packet receiving module configured for receiving the second data packet;
a computer determining module configured for determining if the step motor has rotated to the predetermined position according to the footer data of the second data packet; and
a feedback module configured for outputting error information upon the condition that the step motor has not rotated to the predetermined position.

8. A computer-based method for driving a step motor for controlling a lens module in an image measuring machine, the method comprising:
receiving a first data packet from a computer, wherein the first data packet comprises a header data and a main data, wherein the header data defines an identification of the main data, and wherein the main data defines a numerical zoom value corresponding to a selected magnification level of the lens module;
determining the identification of the main data in the first data packet according to the header data of the first data packet; and
converting the selected magnification level of the lens module into drive signals for driving rotation of the step motor, upon the condition that the identification of the main data is the numerical zoom value corresponding to the selected magnification level of the lens module.

9. The method as described in claim 8, wherein the drive signals comprise a pulse signal and a direction signal.

10. The method as described in claim 8, before the receiving step further comprising:
receiving a zoom command comprising the numerical zoom value corresponding to the selected magnification level of the lens module; and
packing the numerical zoom value to generate the first data packet.

11. The method as described in claim 8, after the converting step further comprising:
packing a rotation result of the step motor to generate a second data packet.

12. The method as described in claim 11, wherein the rotation result comprises information defining whether the step motor 3 has rotated to the predetermined position or not rotated to the predetermined position.

13. The method as described in claim 12, wherein the second data packet comprises a header data, a main data, and a footer data.

14. The method as described in claim 13, further comprising:
receiving the second data packet;
determining if the step motor has rotated to the predetermined position according to the footer data of the second data packet; and
outputting error information upon the condition that the step motor has not rotated to the predetermined position.

15. A storage medium having stored thereon instructions that, when executed by a processor or a computing device, causing the processor or the computing device to perform a method for driving a step motor for controlling a lens module in an image measuring machine, the method comprising:
receiving a first data packet from a computer, wherein the first data packet comprises a header data and a main data, wherein the header data defines an identification of the main data, and wherein the main data defines a numerical zoom value corresponding to a selected magnification level of the lens module;
determining the identification of the main data in the first data packet according to the header data of the first data packet; and
converting the selected magnification level of the lens module into drive signals for driving rotation of the step motor, upon the condition that the identification of the main data is the numerical zoom value corresponding to the selected magnification level of the lens module.

16. The storage medium as described in claim 15, wherein the drive signals comprise a pulse signal and a direction signal.

17. The storage medium as described in claim 15, wherein the method further comprises:
receiving a zoom command comprising the numerical zoom value corresponding to the selected magnification level of the lens module; and
packing the numerical zoom value to generate the first data packet.

18. The storage medium as described in claim 15, wherein the method further comprises:
packing a rotation result of the step motor to generate a second data packet.

19. The storage medium as described in claim 18, wherein the second data packet comprises a header data, a main data, and a footer data.

20. The storage medium as described in claim 18, wherein the method further comprises:
receiving the second data packet;
determining if the step motor has rotated to the predetermined position according to the footer data of the second data packet; and
outputting error information upon the condition that the step motor has not rotated to the predetermined position.
